(19) United States
(12) Patent Application Publication
(10) Pub. No.: US 2020/0391073 A1
(43) Pub. Date: Dec. 17, 2020

(54) Combined Exercising Mat and Massaging Roller

(71) Applicant: YOOStir, LLC, Sherman Oaks, CA (US)

(72) Inventor: Tony R. Smith, JR., Sherman Oaks, CA (US)

(21) Appl. No.: 16/785,517

(22) Filed: Feb. 7, 2020

Related U.S. Application Data
(60) Provisional application No. 62/859,731, filed on Jun. 11, 2019.

(51) Int. Cl. A63B 21/00; A61H 15/00; A63B 23/00

(52) U.S. Cl. CPC A63B 21/4037; A61H 15/0092; A61H 2201/169; A61H 2201/0157; A61H 2201/1671; A63B 2023/006; A61H 2015/0014

(57) ABSTRACT

A combined exercise mat and massaging roller is an apparatus used to perform exercises, especially bodyweight floor-based exercises and mobility work. The apparatus is configured to connect and disconnect easily for conversion between an exercise surface and an acute-pressure-supplying roller device. The apparatus includes an exercise mat, a plurality of massaging protrusions, and a snapping mechanism. The exercise mat provides a clean and comfortable exercise surface for a variety of yoga or body weight exercises. The plurality of massaging protrusions relates to a set of features that extend from the exercise mat to provide stimulation to various muscle groups and tissue during rolling. The snapping mechanism is a series of interlocking fasteners that engage with each other to secure the apparatus into a rolling configuration and subsequently release to toggle back into a flat configuration. The configuration of these components allows the apparatus to provide an exercise surface and roller.

The current application claims a priority to the U.S. Provisional Patent application Ser. No. 62/859,731 filed on Jun. 11, 2019.

### FIELD OF THE INVENTION

The present invention generally relates to an exercise tool. More specifically, the combined exercising mat and massaging roller relates to a device that enables a user to perform yoga or other floor-based exercises, and simultaneously adapts into a roller shape to enable the user to address tight muscles and fascia before or upon completion of a workout.

### BACKGROUND OF THE INVENTION

In an age in which the bulk of the modern workforce is increasingly sedentary, the need for innovative exercise modes and mechanisms is correspondingly increasing. Many sedentary workers therefore register for gyms and fitness programs, often following the most recent exercise and health advice. Many such programs involve performing body weight exercises, which often rely upon balancing and working against the ground. Yoga in particular requires a large amount of balance and strength, especially as poses and positions become more advanced. Yoga exercises, along with a variety of other bodyweight exercises, are made more accessible through the usage of cushions, pads, and especially mats. Such tools can protect the user's knees and elbows, afford a level of general comfort during exercises, and ensure a clean exercising surface. Further, there is an increasing appreciation for myofascial release, which is made possible through the use of massaging tools including various balls and especially tubular rollers.

However, as the need for an ever-increasing quantity of devices grows, so too does the difficulty of being prepared for a workout. Planning a workout requires several tools with different functions in order to address the different target areas of the body. The size and weight of the travel containers and gym bags increases, as does the challenge of hauling such bags to and from a workout area. In addition, loading such a bag becomes a frustrating task, as different items require different amounts of space. What is needed is a device which combines exercise functionalities to provide convenient and effective stimulation and support for a user. Further desirable is a device which allows the user to perform floor-based exercises and subsequently perform mobility and maintenance movements.

The present invention addresses these issues. The combined exercise mat and massage roller provides a flexible surface capable of rolling and unrolling for convenience of transportation. The user may therefore easily unfurl the present invention to provide a clean and comfortable exercise surface. The present invention also snaps into the shape of a sturdy muscle roller in the rolled configuration. The user may utilize the roller, along with its various protrusions and features, to stimulate myofascial release, thus providing not only a muscle-relaxing sensation but also enhancing muscular flow to various tight regions after a workout. The present invention easily unsnaps to enable the user to roll out a workout mat as desired.

### BRIEF DESCRIPTION OF THE DRAWINGS

FIG. 1 is a right-top perspective view of the present invention.

FIG. 2 is a left-bottom perspective view of the present invention.

FIG. 3 is a bottom view of the present invention.

FIG. 4 is a front view of the present invention.

FIG. 5 is a top view showing the at least one resistance band of the present invention.

FIG. 6 is a schematic diagram representing a front view of the present invention in a rolled configuration.

FIG. 7 is a schematic diagram representing a top view of the present invention in a rolled configuration.

### DETAILED DESCRIPTION OF THE INVENTION

All illustrations of the drawings are for the purpose of describing selected versions of the present invention and are not intended to limit the scope of the present invention.

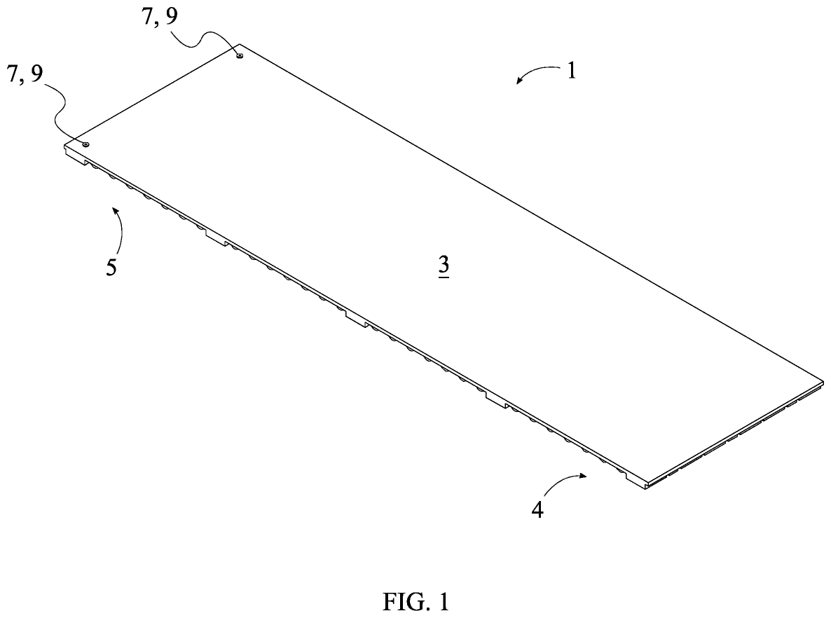

The present invention is a combined exercise mat and massaging roller that is used to perform exercises, especially body weight floor-based exercises and mobility work. The present invention is also configured to connect and disconnect easily for quick conversion between a clean exercise surface and an acute-pressure-supplying roller device. A preferred embodiment of the present invention comprises an exercise mat 1, a plurality of massaging protrusions 6, and a snapping mechanism 7, as shown in FIG. 1. The exercise mat 1 relates to a flexible structure, preferably made of semirigid foam or other shock-absorbent polymeric materials, that provides a clean and comfortable exercise surface for a variety of yoga or body weight exercises. The plurality of massaging protrusions 6 relates to a set of features that extend from the exercise mat 1 to provide stimulation to various muscle groups and tissue during rolling. The plurality of massaging protrusions 6 may relate to features which are flat, domed, or otherwise curved, thereby providing the user with the ability to provide both acute pressure and broad pressure to targeted areas. Furthermore, the plurality of massaging protrusions 6 may include a set of ball bearings or plate bearings that enable massaging features to rotate, thus providing the user with a variety of muscular stimulation options and effects. The snapping mechanism 7 is a series of interlocking fasteners that engage with each other to secure the present invention into a rolling configuration, and subsequently release to toggle back into an unrolled configuration.

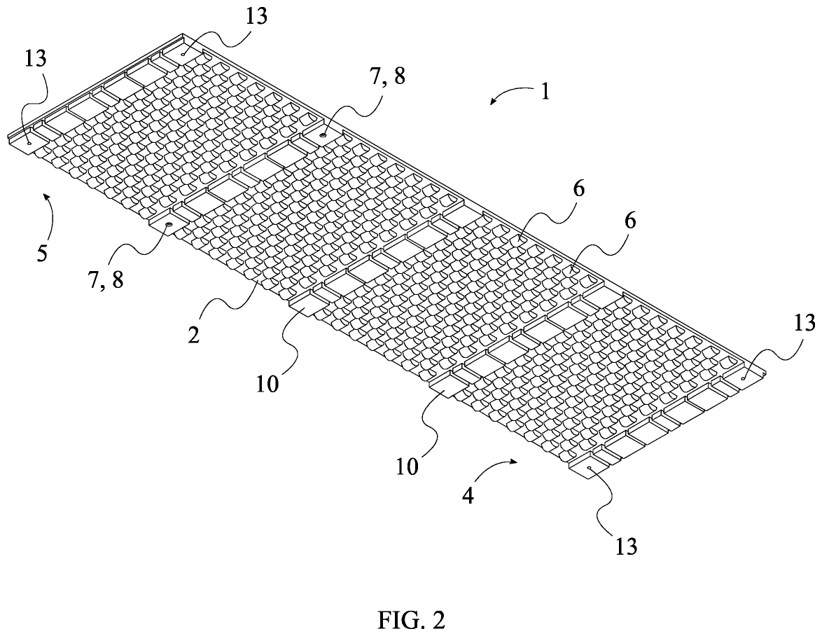

The general configuration of the aforementioned components allows the present invention to efficiently and effectively provide an exercise surface and roller for various exercise routines. The exercise mat 1 comprises a first face 2, a second face 3, a proximal end 4, and a distal end 5, as shown in FIG. 2. The first face 2 is a surface of the exercise mat 1 which provides an interface for a variety of rolling movements. The second face 3 is a surface of the exercise mat 1 opposite the first face 2 which provides a generally flat area optimized for body weight and yoga exercises. The proximal end 4 relates to an edge of the exercise mat 1 which enables connection to the distal end 5. Similarly, the distal end 5 relates to an edge of the exercise mat 1 which enables connection to the proximal end 4, thus allowing the present invention to roll into the rolled configuration. The snapping mechanism 7 comprises at least one first interlocking piece 8 and at least one second interlocking piece 9. The at least one first interlocking piece 8 relates to a fastener, especially a snap button, which joins with the at least one second interlocking piece 9 to secure the present invention into the rolled configuration. Similarly, the at least one second interlocking piece 9 relates to a fastener, especially a snap receiver, which joins with the at least one first interlocking piece 8 to secure the present invention into the rolled configuration. The plurality of massaging protrusions 6 is distributed across the first face 2. This arrangement provides the user with the ability to apply acute pressure to a range of targeted areas. Each of the plurality of massaging protrusions 6 is connected onto the first face 2. In this way, the user may apply pressure onto a targeted area of the user during rolling to achieve desired soft tissue stimulation.

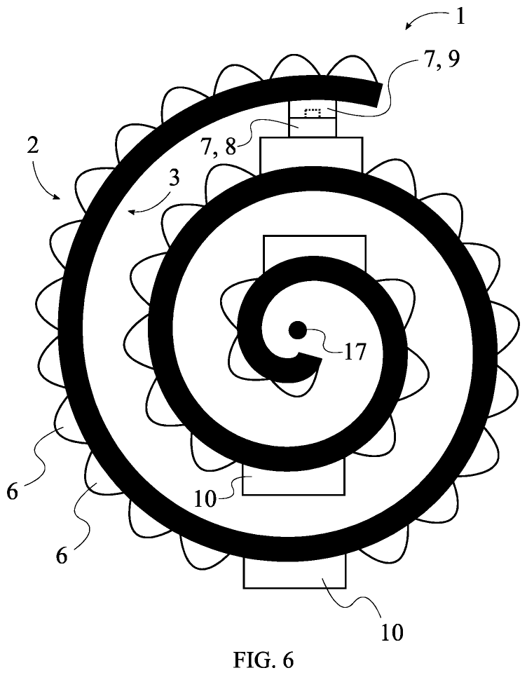

The present invention requires a mechanism for securing the exercise mat 1 into a rolled configuration. The at least one first interlocking piece 8 is connected onto the first face 2, as represented in FIG. 6. This arrangement enables appropriate interaction of the at least one first interlocking piece 8 with the at least one second interlocking piece 9. Furthermore, the at least one first interlocking piece 8 is positioned offset from the distal end 5. Thus, the at least one first interlocking piece 8 is positioned appropriately to engage with the at least one second interlocking piece 9. Conversely, the at least one second interlocking piece 9 is connected onto the second face 3. This arrangement enables appropriate interaction of the at least one second interlocking piece 9 with the at least one first interlocking piece 8. Furthermore, the at least one second interlocking piece 9 is positioned adjacent to the distal end 5. Thus, the at least one second interlocking piece 9 is positioned appropriately to engage with the at least one first interlocking piece 8, so that when the present invention is shifted into the rolled configuration, the at least one first interlocking piece 8 aligns with the at least one second interlocking piece 9.

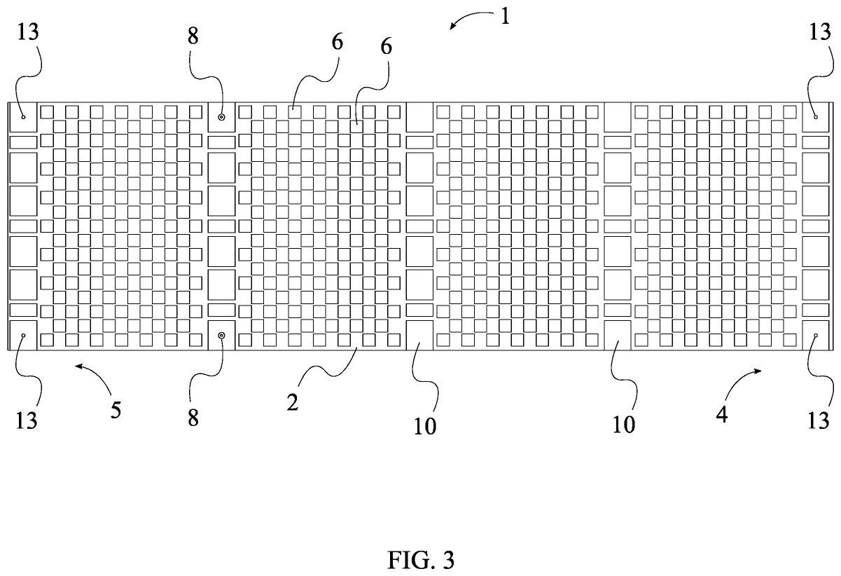

It is often preferable for the roller to secure through connection to a series of fasteners. To this end, the at least one first interlocking piece 8 traverses across the exercise mat 1, as shown in FIG. 3. In this arrangement, the at least one first interlocking piece 8 includes multiple interlocking pieces, preferably aligned widthwise across the exercise mat 1. Similarly, the at least one second interlocking piece 9 traverses across the exercise mat 1. The at least one second interlocking piece 9 also includes multiple pieces, each connecting to a corresponding piece from the at least one first interlocking piece 8. The at least one first interlocking piece 8 and the at least one second interlocking piece 9 are positioned parallel to each other. Thus, the at least one first interlocking piece 8 and the at least one second interlocking piece 9 are able to interconnect with each other in order to secure the present invention in the rolled-up configuration.

The user may desire to utilize the present invention as a muscular roller for myofascial maintenance purposes. To achieve this, the exercise mat 1 and the plurality of massaging protrusions 6 are arranged into a muscle-roller configuration. In such a configuration, it becomes easy for the user to apply body weight onto the present invention to target sensitive, painful, overworked, or under-stimulated areas of the user's body. The exercise mat 1 is coiled into a rolled configuration, as represented in FIG. 6. This arrangement enables the user to effectively roll atop the exercise mat 1 to achieve desired muscular stimulation. The first face 2 is radially oriented away from a rotation axis 17 of the rolled configuration. Such an arrangement enables appropriate positioning of the plurality of massaging protrusions 6 for ease of accessibility by the user. Conversely, the second face 3 is radially oriented towards from the rotation axis 17 of the rolled configuration. In this way, the generally flat surface optimized for supporting the user during yoga or body weight exercises faces away from the user during rolling activities. The plurality of massaging protrusions 6 is pressed against the second face 3. Such an arrangement provides structural support throughout the present invention during rolling exercises. The at least one first interlocking piece 8 is engaged with the at least one second interlocking piece 9. Thus, the exercise mat 1 is constricted into the roller configuration, preventing undesired unrolling of the exercise mat 1 during use.

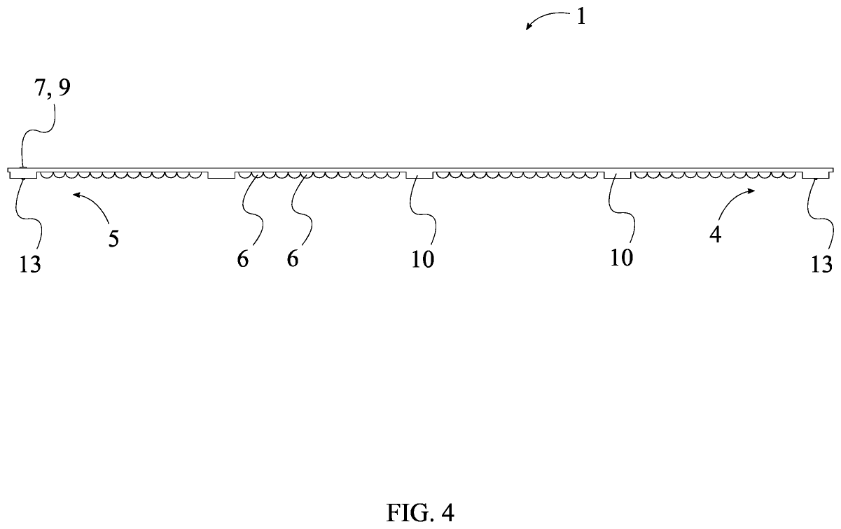

The user benefits from a series of physical and visual features which makes the alignment of the at least one first interlocking piece 8 with the at least one second interlocking piece 9 more intuitive. To achieve this, the present invention may further comprise a plurality of alignment features 10, as shown in FIG. 4. The plurality of alignment features 10 relates to a series of indicators that allow the user to monitor the exercise mat 1 as the exercise mat 1 is wound into the rolled configuration. The plurality of alignment features 10 is integrated amongst the plurality of massaging protrusions 6. Thus, the user may monitor the position of the plurality of alignment features 10 to increase awareness of the position of the plurality of massaging protrusions 6. The plurality of alignment features 10 is evenly distributed from the proximal end 4 to the distal end 5. In this way, the plurality of alignment features 10 is set to help the user to determine the alignment of the at least one first interlocking piece 8 with the at least one second interlocking piece 9. As can be seen in FIG. 6, the plurality of alignment features 10 is serially positioned onto each other. In this arrangement, the plurality of alignment features 10 is positioned to enhance the overall strength of the roller configuration.

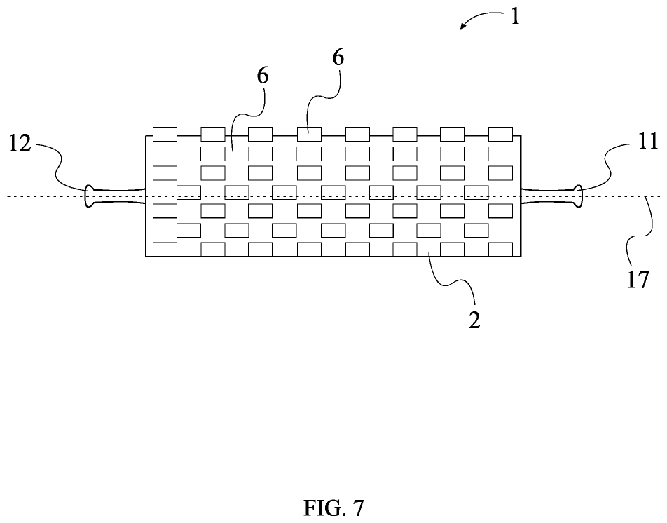

Several instances of mobility rolling work require the user to have leverage over the roller device. To achieve this, the present invention may further comprise a first handlebar 11 and a second handlebar 12, as represented in FIG. 7. The first handlebar 11 and the second handlebar 12 are two ergonomic protrusions that extend from the exercise mat 1 to provide the user with leverage during rolling exercises. The first handlebar 11 is rotatably and laterally attached to the exercise mat 1. Such an arrangement enables the user to grasp the first handlebar 11 to direct pressure application from the exercise mat 1. Similarly, the second handlebar 12 is rotatably and laterally attached to the exercise mat 1, opposite the first handlebar 11. In this way, the user is able to apply even pressure to various portions of the user's body. The first handlebar 11, the second handlebar 12, and the rotation axis 17 are coaxially positioned with each other. Thus, the user may apply pressure to targeted areas of the body.

The present invention is also optimized for usage as a yoga or body weight exercise tool. To this end, the exercise mat 1 and the plurality of massaging protrusions 6 are arranged into a yoga-mat configuration, as shown in FIG. 4. In this configuration, the user may perform a variety of body weight and yoga exercises in a comfortable and sanitary manner. The exercise mat 1 is positioned into a flat configuration. Such a configuration provides the user with a wide surface upon which to exercise. The plurality of massaging protrusions 6 is oriented normal to the exercise mat 1. In this way, the plurality of massaging protrusions 6 is oriented to support the second face 3 in optimal position for usage.

The exercise mat 1 may be placed upon a floor that is slippery, or the user may be performing exercises that may make a low friction mat slip upon the ground. To this end, the present invention may further comprise a plurality of floor grips 13, as shown in FIG. 2. The plurality of floor grips 13 is a series of high friction additions to the exercise mat 1 that prevent the exercise mat 1 from slipping during use. The plurality of floor grips 13 is connected across the first face 2. This arrangement ensures that the first face 2, which preferably contacts the floor or ground during use, may retain the position of the exercise mat 1 during use.

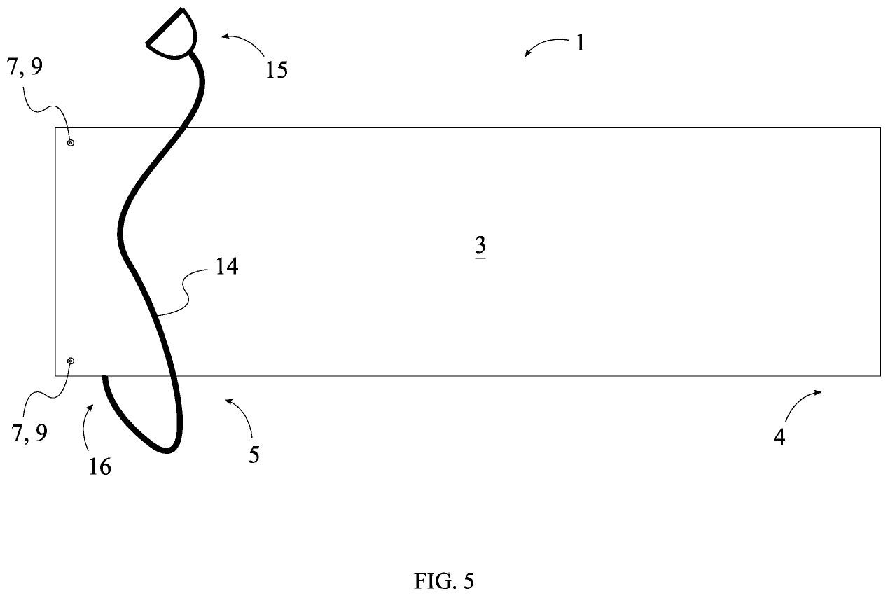

The user of the present invention may further desire to perform resistance exercises. To provide for this need, the present invention may further comprise at least one resistance band 14, as shown in FIG. 5. The at least one resistance band 14 relates to an elastic unit which connects to the exercise mat 1, thereby allowing a user to perform resistance exercises against the user's own weight. The at least one resistance band 14 comprises a free band end 15 and a fixed band end 16. The fixed band end 16 relates to the segment of the at least one resistance band 14 that tethers to the exercise mat 1. The free band end 15 relates to the segment of the at least one resistance band 14 which the user may interact with. The fixed band end 16 is laterally coupled to the exercise mat 1. Such an arrangement enables the user to pull against the at least one resistance band 14 to stimulate various muscle groups.

Although the invention has been explained in relation to its preferred embodiment, it is to be understood that many other possible modifications and variations can be made without departing from the spirit and scope of the invention as hereinafter claimed.

What is claimed is:

1. A combined exercising mat and massaging roller comprises:
an exercise mat;
a plurality of massaging protrusions;
a snapping mechanism;
the exercise mat comprises a first face, a second face, a proximal end, and a distal end;
the snapping mechanism comprises at least one first interlocking piece and at least one second interlocking piece;
the plurality of massaging protrusions being distributed across the first face;
each of the plurality of massaging protrusions being connected onto the first face;
the at least one first interlocking piece being connected onto the first face;
the at least one first interlocking piece being positioned offset from the distal end;
the at least one second interlocking piece being connected onto the second face; and
the at least one second interlocking piece being positioned adjacent to the distal end.

2. The combined exercising mat and massaging roller as claimed in claim 1 comprises:
the at least one first interlocking piece traversing across the exercise mat;
the at least one second interlocking piece traversing across the exercise mat; and
the at least one first interlocking piece and the at least one second interlocking piece being positioned parallel to each other.

3. The combined exercising mat and massaging roller as claimed in claim 1 comprises:
wherein the exercise mat and the plurality of massaging protrusions are arranged into a muscle-roller configuration;
the exercise mat being coiled into a rolled configuration;
the first face being radially oriented away from a rotation axis of the rolled configuration;
the second face being radially oriented towards from the rotation axis of the rolled configuration;
the plurality of massaging protrusions being pressed against the second face; and
the at least one first interlocking piece being engaged with the at least one second interlocking piece.

4. The combined exercising mat and massaging roller as claimed in claim 3 comprises:
a plurality of alignment features;
the plurality of alignment features being integrated amongst the plurality of massaging protrusions;
the plurality of alignment features being evenly distributed from the proximal end to the distal end; and
the plurality of alignment features being serially positioned onto each other.

5. The combined exercising mat and massaging roller as claimed in claim 3 comprises:
a first handlebar;
a second handlebar;
the first handlebar being rotatably and laterally attached to the exercise mat;
the second handlebar being rotatably and laterally attached to the exercise mat, opposite the first handlebar; and
the first handlebar, the second handlebar, and the rotation axis being coaxially positioned with each other.

6. The combined exercising mat and massaging roller as claimed in claim 1 comprises:
wherein the exercise mat and a plurality of massaging protrusions is arranged into a yoga-mat configuration;
the exercise mat being positioned into a flat configuration; and
the plurality of massaging protrusions being oriented normal to the exercise mat.

7. The combined exercising mat and massaging roller as claimed in claim 1 comprises:
a plurality of floor grips; and
the plurality of floor grips being connected across the first face.

8. The combined exercising mat and massaging roller as claimed in claim 1 comprises:
at least one resistance band;
the at least one resistance band comprises a free band end and a fixed band end; and
the fixed band end being laterally coupled to the exercise mat.

9. A combined exercising mat and massaging roller comprises:
an exercise mat;
a plurality of massaging protrusions;
a snapping mechanism;
the exercise mat comprises a first face, a second face, a proximal end, and a distal end;
the snapping mechanism comprises at least one first interlocking piece and at least one second interlocking piece;
the plurality of massaging protrusions being distributed across the first face;
each of the plurality of massing protrusions being connected onto the first face;
the at least one first interlocking piece being connected onto the first face;
the at least one first interlocking piece being positioned offset from the distal end;
the at least one second interlocking piece being connected onto the second face;
the at least one second interlocking piece being positioned adjacent to the distal end;
the at least one first interlocking piece traversing across the exercise mat;
the at least one second interlocking piece traversing across the exercise mat; and
the at least one first interlocking piece and the at least one second interlocking piece being positioned parallel to each other.

10. The combined exercising mat and massaging roller as claimed in claim 9 comprises:
wherein the exercise mat and the plurality of massaging protrusions are arranged into a muscle-roller configuration;
the exercise mat being coiled into a rolled configuration;
the first face being radially oriented away from a rotation axis of the rolled configuration;
the second face being radially oriented towards from the rotation axis of the rolled configuration;
the plurality of massaging protrusions being pressed against the second face; and
the at least one first interlocking piece being engaged with the at least one second interlocking piece.

11. The combined exercising mat and massaging roller as claimed in claim 10 comprises:
a plurality of alignment features;
the plurality of alignment features being integrated amongst the plurality of massaging protrusions;
the plurality of alignment features being evenly distributed from the proximal end to the distal end; and
the plurality of alignment features being serially positioned onto each other.

12. The combined exercising mat and massaging roller as claimed in claim 10 comprises:
a first handlebar;
a second handlebar;
the first handlebar being rotatably and laterally attached to the exercise mat;
the second handlebar being rotatably and laterally attached to the exercise mat, opposite the first handlebar; and
the first handlebar, the second handlebar, and the rotation axis being coaxially positioned with each other.

13. The combined exercising mat and massaging roller as claimed in claim 9 comprises:
wherein the exercise mat and a plurality of massaging protrusions is arranged into a yoga-mat configuration;
the exercise mat being positioned into a flat configuration; and
the plurality of massaging protrusions being oriented normal to the exercise mat.

14. The combined exercising mat and massaging roller as claimed in claim 9 comprises:
a plurality of floor grips; and
the plurality of floor grips being connected across the first face.

15. The combined exercising mat and massaging roller as claimed in claim 9 comprises:
at least one resistance band;
the at least one resistance band comprises a free band end and a fixed band end; and
the fixed band end being laterally coupled to the exercise mat.

16. A combined exercising mat and massaging roller comprises:
an exercise mat;
a plurality of massaging protrusions;
a snapping mechanism;
a plurality of alignment features;
the exercise mat comprises a first face, a second face, a proximal end, and a distal end;
the snapping mechanism comprises at least one first interlocking piece and at least one second interlocking piece;
the plurality of massaging protrusions being distributed across the first face;
each of the plurality of massing protrusions being connected onto the first face;
the at least one first interlocking piece being connected onto the first face;
the at least one first interlocking piece being positioned offset from the distal end;
the at least one second interlocking piece being connected onto the second face;
the at least one second interlocking piece being positioned adjacent to the distal end;
the at least one first interlocking piece traversing across the exercise mat;
the at least one second interlocking piece traversing across the exercise mat;
the at least one first interlocking piece and the at least one second interlocking piece being positioned parallel to each other;
the plurality of alignment features being integrated amongst the plurality of massaging protrusions;
the plurality of alignment features being evenly distributed from the proximal end to the distal end; and
the plurality of alignment features being serially positioned onto each other.

17. The combined exercising mat and massaging roller as claimed in claim 16 comprises:
wherein the exercise mat and the plurality of massaging protrusions are arranged into a muscle-roller configuration;
a first handlebar;
a second handlebar;
the exercise mat being coiled into a rolled configuration;
the first face being radially oriented away from a rotation axis of the rolled configuration;
the second face being radially oriented towards from the rotation axis of the rolled configuration;
the plurality of massaging protrusions being pressed against the second face;
the at least one first interlocking piece being engaged with the at least one second interlocking piece;
the first handlebar being rotatably and laterally attached to the exercise mat;
the second handlebar being rotatably and laterally attached to the exercise mat, opposite the first handlebar; and
the first handlebar, the second handlebar, and the rotation axis being coaxially positioned with each other.

18. The combined exercising mat and massaging roller as claimed in claim 16 comprises:
wherein the exercise mat and a plurality of massaging protrusions is arranged into a yoga-mat configuration;
the exercise mat being positioned into a flat configuration; and
the plurality of massaging protrusions being oriented normal to the exercise mat.

19. The combined exercising mat and massaging roller as claimed in claim 16 comprises:
a plurality of floor grips; and
the plurality of floor grips being connected across the first face.

20. The combined exercising mat and massaging roller as claimed in claim 16 comprises:
at least one resistance band;
the at least one resistance band comprises a free band end and a fixed band end; and
the fixed band end being laterally coupled to the exercise mat.
